(19) United States
(12) Patent Application Publication
(10) Pub. No.: US 2003/0140067 A1
(43) Pub. Date: Jul. 24, 2003

(54) Systems and methods for sending documents

(76) Inventors: Robert Sesek, Boise, ID (US); Chris Struble, Boise, ID (US); Chad Stevens, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/052,735

(22) Filed: Jan. 18, 2002

(51) Int. Cl. G06F 12/00

(52) U.S. Cl. 707/203

(57) ABSTRACT

Systems and methods for sending documents, are provided. An embodiment of the system is configured to determine whether a user sent a copy of a document to a first set of at least one recipient; and if the user sent the copy of the document to the at least one recipient of the first set, the system is configured to correlate information with the document so that a copy of a revised version of the document can be sent automatically.

### FIELD OF THE INVENTION

The present invention is generally related to the field of communications and, more particularly, is related to systems and methods for sending documents.

### DESCRIPTION OF RELATED ART

In conventional systems, an author of a document sends copies of the document by inserting e-mail addresses of recipients, to whom the author wants to send the copies, into an e-mail application and attaching the document to an email message. After the author sends copies of the document, the author may edit the document and may wish to send copies of the edited document to all the recipients to whom the author initially sent copies of one or more previous version(s) of the document. The author, when sending the copies of the edited document, has to generally check a list of sent messages in the e-mail application, and manually cut and paste the e-mail addresses of the people to whom the author sent copies of the previous version(s) of the document. Checking the list and manually cutting and pasting may not be possible since the author or the e-mail application may have deleted the e-mail message or e-mail addresses of the people to whom the author sent copies of the previous version(s).

Furthermore, in conventional systems, the recipients generally rely on the author to provide the copies of the edited document since the recipients typically do not obtain the copies of the edited document unless the author sends them. However, the recipients may check a Website or a shared network location for obtaining the copies of the edited document. In such a scenario, the recipients may have to remember the Website or the shared network location, or could rely on the author to obtain the Website or the shared network location. Moreover, to facilitate such a process, the author typically would have to update the version number or filename of the copies of the document so that the recipients can obtain copies of the latest version of the document. Such a process may be problematic since the author may enter an incorrect version number or filename, or may fail to place the latest version on the Website or the shared network location.

Based on the foregoing, it should be appreciated that there is a need for improved systems and methods that address the above-mentioned and/or other inadequacies and/or deficiencies.

### SUMMARY OF THE INVENTION

The present invention provides systems and methods for sending documents. Briefly described, in architecture, one embodiment of the system, among others, can be configured to determine whether a user sent a copy of a document to a first set of at least one recipient; and if the user sent the copy of the document to the at least one recipient of the first set, the system is configured to correlate information with the document so that a copy of a revised version of the document can be sent automatically.

The present invention can also be viewed as providing a method for sending documents. In this regard, one embodiment of such a method, among others, can be broadly summarized by: determining whether a user sent a copy of a document to a first set of at least one recipient; and if the user sent the copy of the document to the at least one recipient of the first set, correlating information with the document so that a copy of a revised version of the document can be sent automatically to the at least one recipient of the first set.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of an embodiment of a communications system of the present invention.

FIG. 2 is a block diagram of an embodiment of a computer or a processor-based device that can be used to implement a document-sending system of FIG. 1.

FIG. 3 is a flowchart of an embodiment of a method for sending documents.

FIGS. 4A-4C are flowcharts of an alternative embodiment of the method for sending documents.

### DETAILED DESCRIPTION

As will be described in detail herein, systems and methods of the invention can potentially enable a user to send copies of a revised version of a document to recipients who received copies of previous version(s) of the document. In this regard, the user need not remember who received the previous version(s) of the document. Furthermore, the user need not cut and paste the e-mail addresses of the recipients to whom the user sent the previous version(s) of the document. Additionally, the recipients can receive copies of the revised version of the document without relying on the user to remember to send them the copies since in some embodiments, sending of the revised versions can be accomplished automatically. In some embodiments, correlating information with the document enables the user to automatically send and the recipients to automatically receive copies of the revised versions of the document.

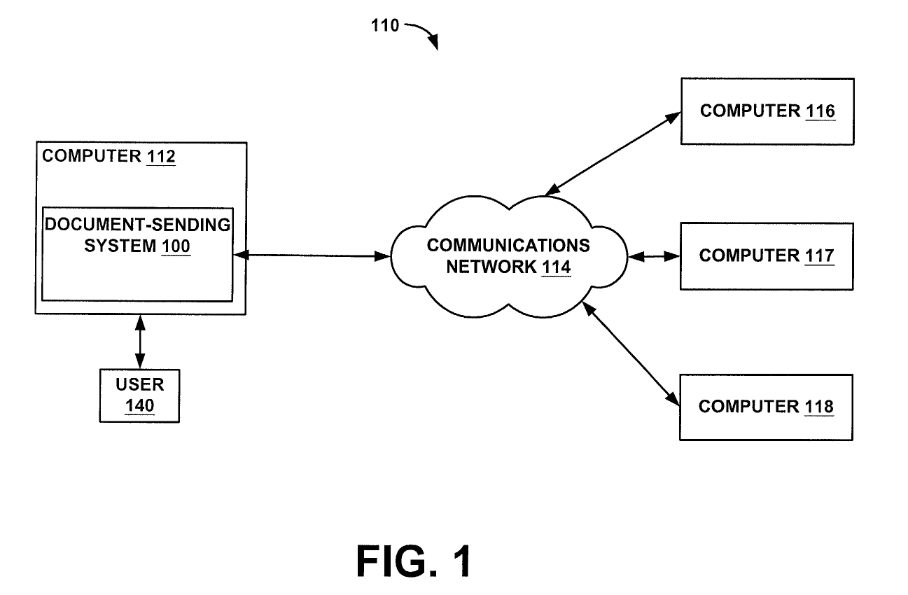

FIG. 1 is a block diagram of an embodiment of a communications system 110 that includes a document-sending system 100 for sending documents. The communications system 110 includes a computer 112, a communications network 114, and computers 116-118. Each of the computers 112, 116-118 can be, for instance, a special or a general purpose digital computer, such as a personal computer (PC), workstation, mini-computer, or a mainframe computer. The PC can be IBM® compatible, or Apple® compatible. Each of the computers 112, 116-118 can alternatively, also be a personal digital assistant (PDA), an e-book reader, or a portable electronic device capable of receiving and displaying a document. The communications network 114 can be, for example, an RS-232, a BlueTooth wireless connection, an 802.11 wireless network, a public service telephone network (PSTN), an integrated service digital network (ISDN), or any other communications network.

The computer 112 includes the document-sending system 100. A user 140 uses the document-sending system 100, and the computer 112 communicates with the computers 116-118 via the communications network 114. Recipients use the computers 116-118.

The document-sending system 100 can be implemented in software, firmware, hardware, or a combination thereof. In a currently contemplated best mode, the document-sending system 100 is implemented in software, as an executable program, and is executed on the computer 112.

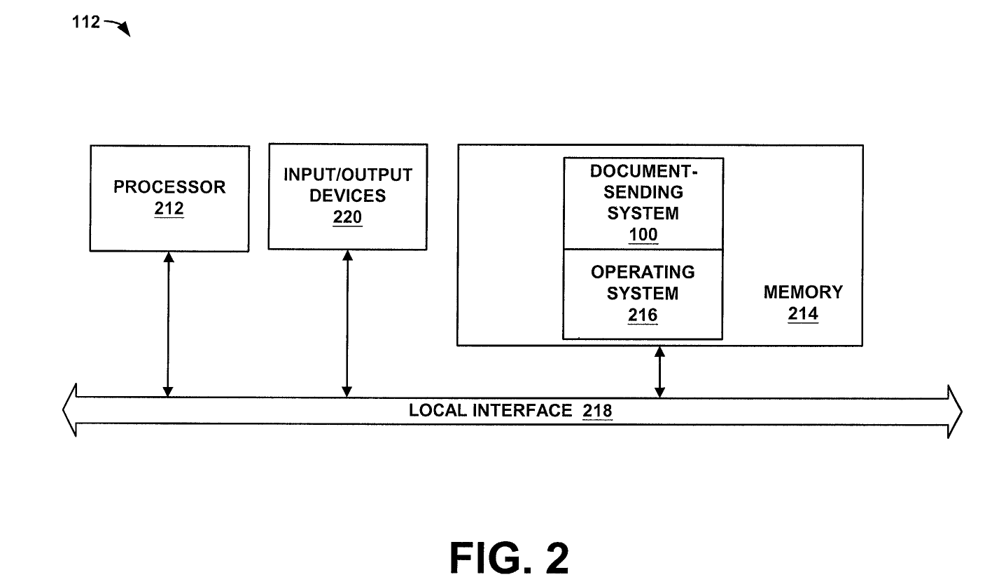

FIG. 2 is a block diagram of an embodiment of the computer 112 of FIG. 1. Generally, in terms of hardware architecture, the computer 112 includes a processor 212, a memory 214, and one or more input and/or output (I/O) devices 220 that are communicatively coupled via a local interface 218. The local interface 218 can be, for example, one or more buses or other wired or wireless connections. The local interface 218 may have additional elements, which are omitted for simplicity, such as controllers, buffers, drivers, repeaters, and receivers, to enable communications. Further, the local interface 218 may include address, control, and/or data connections to enable appropriate communications among the aforementioned components.

The processor 212 is a hardware device for executing software, particularly that stored in memory 214. The processor 212 can be any custom made or commercially available processor, a central processing unit (CPU), an auxiliary processor among several processors associated with the computer 112, a semiconductor based microprocessor in the form of a microchip or chip set, a macroprocessor, or generally any device for executing software instructions.

The memory 214 can include any one or combination of volatile memory elements such as random access memory (RAM) and nonvolatile memory elements such as read-only memory (ROM), hard drive, tape, and Compact Disc ROM (CDROM). Different types of RAM are dynamic RAM (DRAM), static RAM (SRAM), magnetic RAM (MRAM), and synchronous DRAM (SDRAM). Moreover, the memory 214 may incorporate electronic, magnetic, optical, and/or other types of storage media. Note that the memory 214 can have a distributed architecture, where various components are situated remote from one another, but can be accessed by the processor 212.

The software in memory 214 may include one or more separate programs, each of which includes an ordered listing of executable instructions for implementing logical functions. In the embodiment of the computer 112 of FIG. 2, the software in the memory 214 includes the document-sending system 100 and a suitable operating system (O/S) 216. The O/S 216 essentially controls the execution of other computer programs, such as the document-sending system 100, and provides scheduling, input-output control, file and data management, memory management, and communication control and related services.

The document-sending system 100 can be a source program, executable program, script, or any other entity comprising a set of instructions to be performed. When the document-sending system 100 is a source program, the program needs to be translated via a compiler, assembler, interpreter, or the like, which may or may not be included within the memory 214, so as to operate properly in connection with the O/S 216. Furthermore, the document-sending system 100 can be written as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada.

The I/O devices 220 may include input devices, for example, but not limited to, a keyboard, mouse, scanner, and a microphone. Furthermore, the I/O devices 220 may also include output devices, for example, a printer, and a display. Finally, the I/O devices 220 may further include devices that communicate both inputs and outputs, for instance, a modem for accessing another device, system, or network, a radio frequency (RF) or other transceiver, a telephonic interface, a bridge, and a router.

If the computer 112 is a PC, workstation, or the like, the software in the memory 214 may further include a basic input output system (BIOS) (omitted for simplicity). The BIOS is a set of essential software routines that initialize and test hardware at startup, start the O/S 216, and support the transfer of data among the hardware devices. The BIOS is stored in ROM so that the BIOS can be executed when the computer 112 is activated.

When the computer 112 is in operation, the processor 212 is configured to execute software stored within the memory 214, to communicate data to and from the memory 214, and to generally control operations of the computer 112 pursuant to the software. The document-sending system 100 and the O/S 216, in whole or in part, but typically the latter, are read by the processor 212, perhaps buffered within the processor 212, and then executed.

An alternative embodiment of the document-sending system 100 is implemented in hardware. In such an embodiment, the document-sending system 100 is implemented with any or a combination of the following technologies, which are each well known in the art: a discrete logic circuit(s) having logic gates for implementing logic functions upon data signals, an application specific integrated circuit (ASIC) having appropriate combinational logic gates, programmable gate arrays (PGAs), and field programmable gate arrays (FPGAs).

The document-sending system 100 comprises a program that initiates by determining whether or not the user 140 (FIG. 1) sent copies of the document to at least one recipient via the communications network 114 (FIG. 1). The user 140 (FIG. 1) is, for instance, a human being, or a machine such as a robot, who sends copies of the document to the at least one recipient. The user 140 (FIG. 1) may be the author of the document. The copies are sent from the computer 112 (FIG. 1) on which the document was created or alternatively, from the computer 112 (FIG. 1) on which the document was not created but which stores a copy of the document or has access to a copy of the document. The recipient of the copy of the document can be, for instance, a human being, or a machine such as a robot, to whom the user 140 (FIG. 1) intends to send one of the copies of the document. The recipient uses one of the computers 116-118 (FIG. 1) to receive the copy of the document via the communications network 114 (FIG. 1).

The program can be enabled from document applications, or from e-mail applications. For instance, the user 140 (FIG. 1) uses Microsoft® Word, which is an example of the document applications, goes to “File” on a menu, clicks on “Send To,” and clicks on “Mail Recipient”. The selection of “Mail Recipient” starts the program. Examples of the document applications, include, but are not limited to, Wordpad, Adobe® Acrobat Reader, Microsoft® Excel, Microsoft® Photo Editor, Microsoft® PowerPoint, Microsoft® Visio, and any other applications for creating, manipulating, or viewing documents. Alternatively, the user 140 (FIG. 1) may be using Microsoft® Outlook, which is an example of the e-mail applications, and simply attach a copy of the document to an e-mail message. The user 140 (FIG. 1) then clicks on “Send” to send the copies of the document to the at least one recipient. The selection of “Send” starts the program. Examples of e-mail applications include, but are not limited to, Pine®, Hotmail®, Yahoo!® mail, Zensearch™ e-mail, and Juno®. The document is a document created using any of the document applications.

The program continues and correlates information with the document, if the user 140 (FIG. 1) sent the copies of the document to the at least one recipient. An example of the correlation is to encode the document with information. Information includes, for instance, the location of the document in the computer 112 (FIG. 1) that the user 140 (FIG. 1) used to send but not create the copies of the document. Alternatively, the information includes an address of the document in the computer 112 (FIG. 1) that the user 140 (FIG. 1) used to both create the document and send the copies of the document. In another alternative embodiment of the document-sending system 100 (FIG. 1), the information includes a reference to a location of the document in a computer that is separate from, but linked to the computer 112 via a Website or a shared network. In addition to the location of the document in the computer 112 (FIG. 1) or in the separate computer, the information may include email addresses of the at least one recipient. Hence, the document may be encoded with a list of e-mail addresses of the at least one recipient. If the user 140 (FIG. 1) does not send the copies of the document to the at least one recipient, the program ends.

An example of encoding the document with information is to attach a tag or a pointer to the document. The e-mail addresses of the at least one recipient and the location can be in the form of a pointer or a tag that the document includes. The tag can, for example, be a hypertext markup language (HTML) or an extensible markup language (XML) tag. An example of an XML tag is “<document location>”. The user 140 (FIG. 1) can click on the tag to view the e-mail addresses of the at least one recipient and the location. The tag is visible but can be made invisible at the option of the user 140 (FIG. 1). The tag can be automatically included in the document if the user 140 (FIG. 1) sends copies of the document to the at least one recipient.

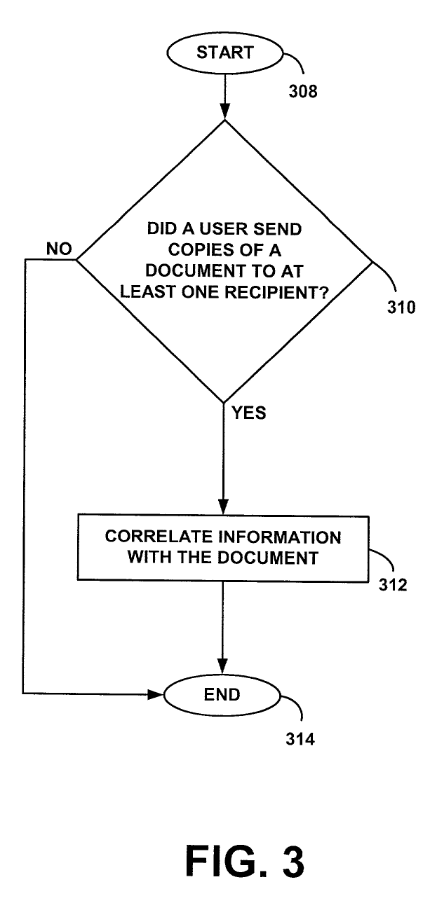

FIG. 3 is a flowchart of an embodiment of a method for sending documents. The method starts with a step 308. In a step 310, there is a determination whether or not the user 140 (FIG. 1) sent copies of the document to at least one recipient. If the user 140 (FIG. 1) sent copies of the document to the at least one recipient, step 312 of the method correlates the information with the document. If the user 140 (FIG. 1) did not send copies of the document to the at least one recipient, the method ends in step 314.

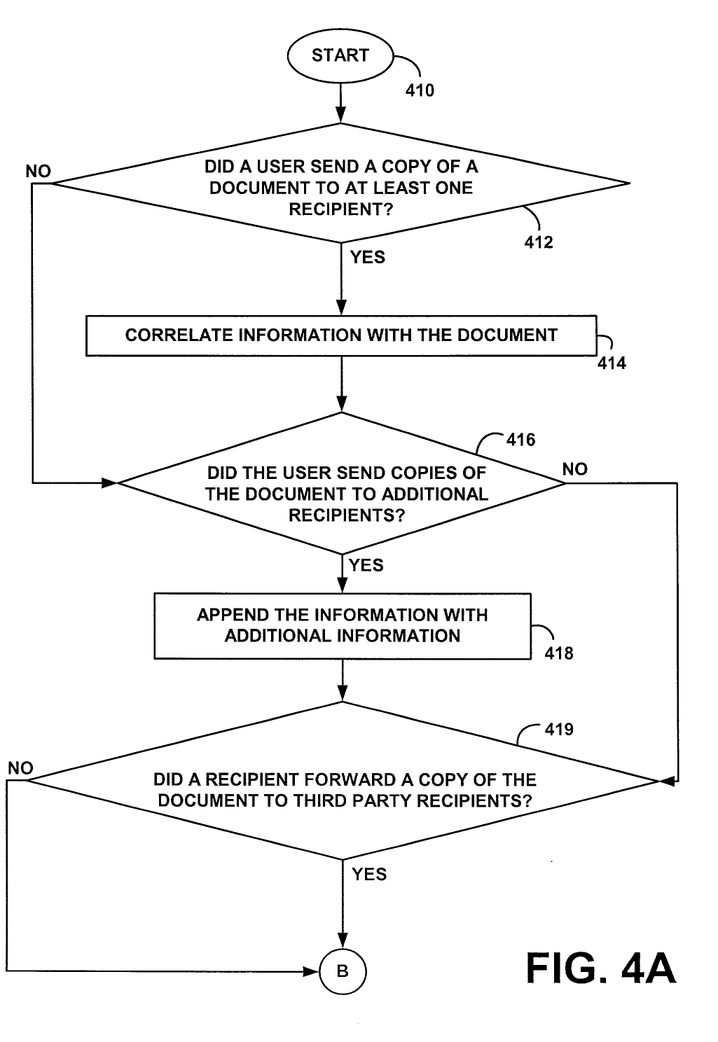

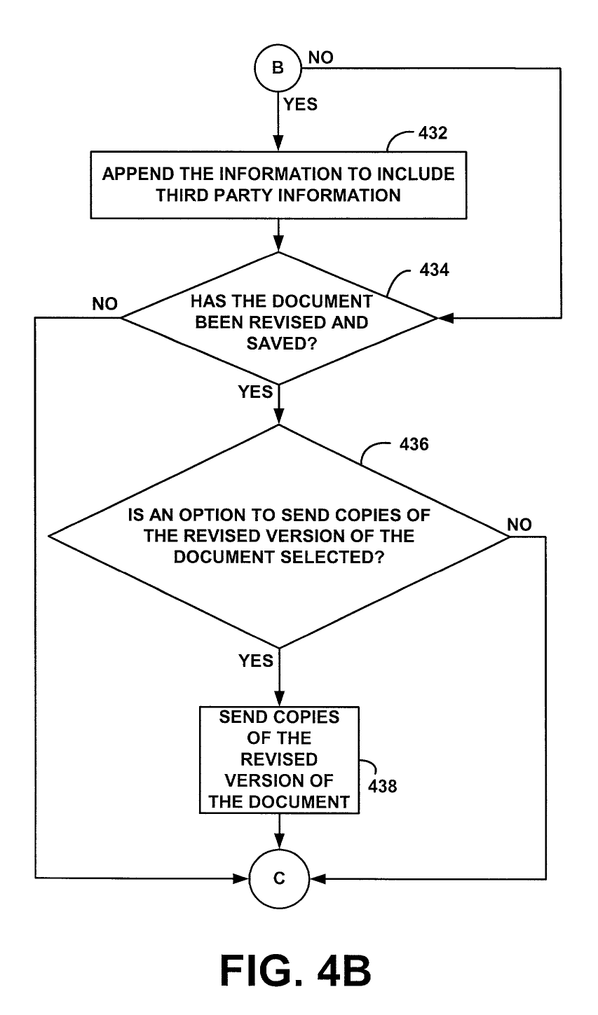

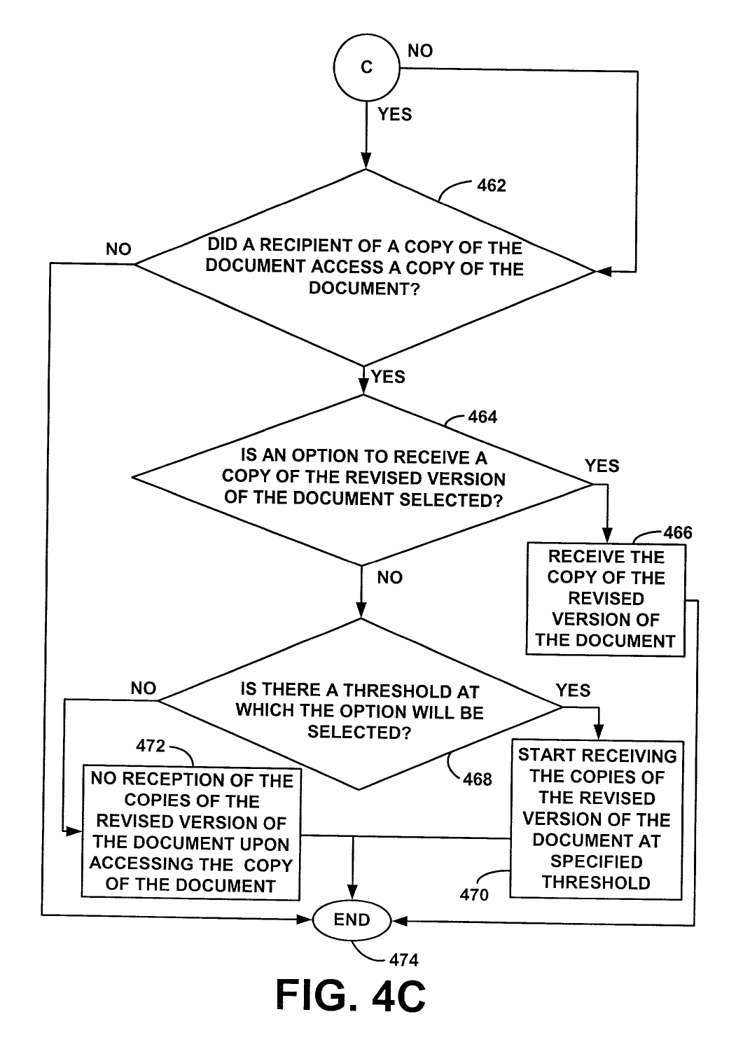

FIGS. 4A-4C are flowcharts of an alternative embodiment of the method for sending documents. The method starts with a step 410. In step 412, there is a determination whether or not the user 140 (FIG. 1) sent copies of the document to the at least one recipient. If the user 140 (FIG. 1) sent copies of the document, step 414 correlates the information with the document. Additionally, each of the copies include the location of the document in the computer 112 (FIG. 1) that the user 140 (FIG. 1) uses to send the copies of the document, or both create the document and send the copies of the document. Moreover, each copy includes an e-mail address of the user 140.

If the user 140 (FIG. 1) did not send copies of the document to the at least one recipient, step 416 follows. Step 416 also follows the step 414. However, in an alternative embodiment of the method, the step 416 may not follow the step 414.

In step 416, there is a determination whether the user 140 (FIG. 1) sent copies of the document to additional recipients via the communications network 114 (FIG. 1). The additional recipients are recipients to whom the user 140 (FIG. 1) intends to send copies of the document after the user 140 (FIG. 1) sent copies of the document to the at least one recipient in the step 412. The additional recipients use the computers 116-118 (FIG. 1).

If the user 140 (FIG. 1) sent copies of the document to the additional recipients, step 418 appends the information in the document with additional information that is related to the additional recipients. The additional information can be, for instance, e-mail addresses of the additional recipients. To elaborate, the copies of the document contain the e-mail address of the user 140 (FIG. 1) in addition to the location of the document in the computer 112 that the user 140 (FIG. 1) uses. The location and the e-mail address are used to append the information in the document with the additional information since the location and the e-mail address are used to recognize that copies of the document were initially sent from the computer 112 (FIG. 1) by the user 140 (FIG. 1).

If the user 140 (FIG. 1) did not send copies of the document to the additional recipients, step 419 follows. Step 419 also follows the step 418. However, in an alternative embodiment of the method, step 419 may not follow step 418. In step 419, there is a determination whether a recipient, among the at least one recipient or among the additional recipients, sent copies of the document, via the communications network 114 (FIG. 1), to recipients regarding whom there is no information that is correlated to the document. The recipients, regarding whom there is no information that is correlated to the document, are referred to as third party recipients, and information related to the third party recipients is referred to as third party information. The third party recipients use the computers 116-118 (FIG. 1). The third party information can comprise, for example, e-mail addresses of the third party recipients.

If the recipient among the at least one recipients or among the additional recipients sent copies of the documents to the third party recipients, in step 432 of FIG. 4B, the information in the document is appended with the third party information. To elaborate, the copies of the document contain the e-mail address of the user 140 (FIG. 1) in addition to the location of the document in the computer 112 that the user 140 (FIG. 1) uses. The location and the e-mail address are used to append the information in the document with the third party information since the location and the e-mail address are used to recognize that copies of the document were initially sent from the computer 112 (FIG. 1) by the user 140 (FIG. 1).

If the recipient among the at least one recipients or among the additional recipients did not send copies of the document to the third party recipients, step 434 follows. Step 434 also follows step 432. However, in an alternative embodiment of the method, step 434 may not follow step 432.

In step 434, there is a determination as to whether the document has been revised and saved by the user 140 (FIG. 1). Revising the document, includes, for instance, editing content of the document, adding data to the content of the document, deleting data from the content of the document, or any other change to the content of the document. The tag is not considered part of the content of the document.

If the document is revised and saved, in step 436, there is a determination as to whether the user 140 (FIG. 1) intends to send copies of the revised version of the document. Whether or not the user 140 (FIG. 1) intends to send copies of the revised version of the document depends on whether or not an option is selected. The option is an option to automatically send copies of the revised version of the document from the computer 112 (FIG. 1), via the communications network 114 (FIG. 1), to all recipients, information regarding whom is correlated to the document. The option can be, for instance, provided to the user 140 (FIG. 1) in the form of a macro or a dialog on a graphical user interface. To illustrate further, when the user 140 (FIG. 1) saves the revised version of the document, the macro or the dialog can ask the user 140 (FIG. 1) whether or not the user 140 (FIG. 1) wants to send copies of the revised version of the document and the user 140 (FIG. 1) can click on a “yes” or a “no” button on the graphical user interface. The user 140 (FIG. 1) can, alternatively, insert an “x” in an empty box besides a dialog that says “send copies of the revised version of the document every time the document is revised and saved.”

If the option is selected, in step 438, copies of the revised version of the document are sent to all the recipients, information regarding whom is correlated to the document. For example, inserting the “x” will automatically send copies of the revised version of the document every time the user 140 (FIG. 1) revises and saves the document. The user 140 (FIG. 1) removes the “x” if the user 140 does not wish to send copies of the revised version of the document every time the document is revised and saved.

If the option is not selected, step 462 of FIG. 4C follows step 436 of FIG. 4B. Moreover, if the document is not revised, or revised but not saved, step 462 follows. Step 462 also follows step 438 (FIG. 4B). However, in an alternative embodiment of the method, step 462 may not follow step 438 (FIG. 4B).

In an alternative embodiment of the method, when the document is revised and saved in step 434 (FIG. 4B), there is a determination whether the user 140 (FIG. 1) has selected an option to send copies of only major revisions of the document. If the option is selected, copies of only major revisions of the document are sent to all recipients, information regarding whom is correlated to the document. The major revisions are the revisions that the user 140 (FIG. 1) designates as major revisions by designating the revised version of the document by an integer. In other words, the user 140 (FIG. 1) uses a versioning system to separate a major revision from a revision that is not a major revision. For instance, under the versioning system, after making major revisions to a document that is designated as “Document version 1.0,” the revised version of the document is designated as “Document version 2” since 2 is an integer. After making revisions that are not major, to a document that is designated as “Document version 1.0,” the revised version of the document is designated as “Document version 1.1” since 1.1 is not an integer. In another alternative embodiment of the method, the major revisions are the revisions that the user 140 (FIG. 1) designates as major revisions by designating the revised version of the document with an extension to the document's name. For instance, if the document is named “Pearlcorder,” the author can designate the revised version of the document as “Pearlcorder.major.”

In yet another alternative embodiment of the method, the processor 212 (FIG. 2) comprises a program to recognize that major revisions are being made to the document from the amount of changes being made to the document, and then designate the revised version of the document using an integer. For instance, if the processor 212 (FIG. 2) recognizes that the user 140 (FIG. 1) has made significant changes to the document, the processor 212 (FIG. 2) automatically designates the revised version of the document as “Document version 3.0” since 3 is an integer. The processor 212 (FIG. 2) can recognize that the user 140 made significant changes from a large number of changes, or changes to a large number of lines in the document. If the processor 212 (FIG. 2) recognizes that the user 140 (FIG. 1) has made insignificant changes, such as correcting a spelling, or adding a comma, the processor 212 (FIG. 2) automatically designates the revised version of the document as “Document version 1.8” since 1.8 is not an integer.

In step 462, there is a determination whether a recipient among the at least one recipient, the additional recipients, and the third party recipients accessed one of the copies of the document. If the recipient accessed the copy of the document, in step 464, there is a determination as to whether the recipient has selected an option to receive one of the copies of the revised version of the document. The computers 116-118 (FIG. 1) can provide the option in the form of, for instance, a macro or a dialog on a graphical user interface. To illustrate further, when the recipient accesses the copy of the document, the macro or the dialog can ask the recipient whether the recipient wants to receive a copy of the revised version of the document. The recipient can click on a “yes” or a “no” button on the graphical user interface. The recipient can, alternatively, insert an “x” beside a dialog that says, “receive the copy of the revised version of the document every time the copy of the document is accessed.” Inserting the “x” is to select the option.

If the option is selected, the recipient receives the copy of the revised version of the document in step 466, and the method ends in step 474. For example, if the recipient inserts the “x,” the recipient receives a copy of the revised version of the document every time the recipient accesses the copy of the document on one of the computers 116-118 (FIG. 1).

If the option is selected, the recipient can receive the copy of the revised version of the document as follows. The copy of the document that is stored on one of the computers 116-118 (FIG. 1), includes the location of the document in the computer 112 (FIG. 1). Additionally, the copy of the document that is stored on one of the computers 116-118 (FIG. 1), includes the e-mail address of the user 140 (FIG. 1). Assume that the computer 118 (FIG. 1) has stored the copy of the document and that the recipient is using the computer 118 (FIG. 1). The computer 118 (FIG. 1) recognizes that the copy of the document was sent from the computer 112 (FIG. 1) by the user 140 because the copy of the document, on the computer 118 (FIG. 1), includes the location of the document and the e-mail address of the user 140 (FIG. 1). The computer 118 (FIG. 1), therefore, also recognizes that it can receive the copy of the revised version of the document from the computer 112 (FIG. 1). If the computer 118 (FIG. 1) recognizes as such, an e-mail message is automatically sent from the computer 118 (FIG. 1) to the computer 112 (FIG. 1) requesting to receive the copy of the revised version of the document. Alternatively, if the computer recognizes as such, the recipient, who is using the computer 118 (FIG. 1), can choose whether to send the request. If the user 140 (FIG. 1) has selected an option to approve requests automatically, the recipient has an option to download the copy of the revised version of the document on the computer 118 (FIG. 1). If the user 140 (FIG. 1) has not selected the option to approve requests automatically, the user 140 (FIG. 1) will be prompted to approve the request. If the user 140 (FIG. 1) approves the request, the recipient has the option to download the copy of revised version of the document on the computer 118 (FIG. 1).

Alternatively, the recipient can use a file transfer protocol to download the copy of the revised version of the document. Furthermore, alternatively, the recipient can simply use a file sharing mechanism via an Intranet to download the copy of the revised version of the document. If the option to receive the copy of the revised version of the document is not selected in step 464, in step 468, there is a determination as to whether there is a threshold at which the option will be selected. The computers 116-118 (FIG. 1) can provide a macro or a dialog on a graphical user interface to the recipient that allows the recipient to select the threshold. The threshold can be, for example, day, date or time at which the option will be selected. To illustrate further, the computers 116-118 (FIG. 1) can provide a graphical user interface with a macro or a dialog stating, “receive a copy of the revised version of the document starting from 06 June 2005.” The recipient can change the day 06, June, 2005 to any date. Moreover, the recipient can insert an “x” in a box besides the macro or the dialog.

If there is a threshold, the recipient, in step 470, will not receive copies of the revised version of the document until that threshold is reached, and will start receiving copies of the revised version of the document from that threshold every time the recipient accesses the copy of the revised version of the document. For example, if the recipient inserts the “x” in the box, and if the recipient accesses the copy of the document on the computer 118 (FIG. 1) on or after 06 June 2005, the recipient starts receiving a copy of the revised version of the document from the computer 112 (FIG. 1) via the communications network 114 (FIG. 1). The recipient does not receive the copies of the revised version of the document prior to 06 June 2005 any time the recipient accesses the copy of the document on the computer 118 (FIG. 1).

If there is no threshold selected, the recipient, in step 472, will not receive the copy of the revised version of the document from the computer 112 (FIG. 1) via the communications network 114 (FIG. 1), every time the recipient accesses the copy of the document on any one of the computers 116-118 (FIG. 1).

The method ends at step 474 if the recipient does not access the copy of the document on any one of the computers 116-118 (FIG. 1). The method ends at step 474 after steps 470 and 472.

In an alternative embodiment of the method, once the document is revised and saved in step 434 (FIG. 4B), the user 140 (FIG. 1) can change the information in the document so that a recipient, information regarding whom is correlated to the document, may not receive a copy of the revised version of the document. If the user 140 (FIG. 4) has changed the information, the recipient will not be sent a copy of the revised version of the document. If the user has not changed the information, the recipient will be sent a copy of the revised version of the document.

For example, when the document is revised and saved, the user is provided with a graphical user interface so that the user 140 (FIG. 1) can remove a mark “x” located besides an e-mail address of the recipient to whom the user 140 (FIG. 1) does not want to send a copy of the revised version of the document. A recipient, whose email address does not have a mark “x” besides it, will not be sent a copy of the revised version of the document. The user 140 (FIG. 1) can, alternatively, delete an e-mail address of a recipient that the user 140 does not want to send a copy of the revised version of the document. The user 140 (FIG. 1) deletes the e-mail address from the document. If the user 140 (FIG. 1) after deleting the e-mail address, wishes to send a copy of the revised version of the document to the recipient, the user 140 (FIG. 1) encodes the information with the e-mail address.

Furthermore, in another embodiment of the method, once the document is revised and saved in step 434 (FIG. 4B), there is a determination whether a recipient, information regarding whom is correlated to the document, changed the information in the document. The recipient can change the information since one the computers 116-118 (FIG. 1) that the recipient uses, has a copy of the document. The copy has the location of the document on the computer 112 (FIG. 1) and the e-mail address of the user 140 (FIG. 1). The recipient changes the information if the recipient does not want to receive a copy of the revised version of the document each time the recipient accesses a copy of the document. The recipient changes the information on a graphical user interface, for instance, by removing a mark “x” located besides his/her e-mail address in the document. The recipient, can alternatively, change the information by deleting his/her e-mail address from the document. In yet another alternative embodiment, if the recipient does not wish to receive the copy of the revised version of the document from the user 140 (FIG. 1), any time the recipient accesses the copy of the document, the recipient deletes the location of the computer 112 (FIG. 1) and the e-mail address of the user 140 (FIG. 1) from the copy of the document. The recipient then does not receive a copy of the revised version of the document any time the recipient accesses a copy of the document. However, if the recipient wishes to receive a copy of the revised version of the document, the recipient does not change the information in the document, and receives a copy of the revised version of the document each time the recipient accesses a copy of the document.

In an alternative embodiment of the method, a recipient, information regarding whom is correlated to the document, receives a copy of the revised version of the document as follows. When the recipient accesses a copy of the document in the step 462 (FIG. 4C), the recipient can click on a tag that includes the e-mail address of the user 140 (FIG. 1) and the location of the document, to view the e-mail address of the user 140 (FIG. 1). The recipient can then use the e-mail address of the user 140 (FIG. 1) to e-mail the user 140 (FIG. 1) to check whether or not the user 140 (FIG. 1) has finished making changes to the document. The recipient, thereafter, decides whether to download the copy of the revised version of the document, or to wait until the user 140 (FIG. 1) has finished making changes to the document. The tag is visible but may be made invisible at the option of the recipient.

Flow charts of FIGS. 3 and 4A-4C show the architecture, functionality, and operation of a possible implementation of the software implementation of the document-sending system 100 of FIGS. 1 and 2, respectively. In this regard, each block represents a module, segment, or portion of code, which includes one or more executable instructions for implementing the specified logical functions. It should also be noted that in some alternative implementations, the functions noted in the blocks may occur out of the order noted in the FIGS. 3 and 4A-4C. For example, two blocks shown in succession in FIG. 4A may in fact be executed substantially concurrently or the blocks may sometimes be executed in the reverse order, depending upon the functionality involved, as will be further clarified below.

The method for sending documents of FIGS. 3 and 4A-C, which includes an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples of the computer-readable medium would include an electrical connection having one or more wires, a portable computer diskette, a RAM, a ROM, an EPROM, an EEPROM, a flash memory, an optical fiber, and a portable CDROM. Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory document-sending system 100.

It should be emphasized that the above-described embodiments of the present invention are merely possible examples of implementations set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A method for sending documents, comprising:
determining whether a user sent a copy of a document to a first set of at least one recipient; and
if the user sent the copy of the document to the at least one recipient of the first set, correlating information with the document so that a copy of a revised version of the document can be sent automatically to the at least one recipient of the first set.

2. The method of claim 1, wherein correlating comprises encoding the document with the information.

3. The method of claim 2, wherein the information comprises a location of the document in a device in which the document was created.

4. The method of claim 2, wherein the information comprises a location of the document in a device from which the document was sent.

5. The method, of claim 4, wherein the information comprises addresses of the at least one recipient of the first set.

6. The method of claim 5, further comprising:
determining whether the user sent the copy of the document to at least one recipient of a second set; and
appending the information with addresses of the at least one recipient of the second set, if the user sent the copy of the document to the at least one recipient of the second set.

7. The method of claim 6, further comprising:
determining whether the at least one recipient of the second set sent the copy of the document to at least one recipient of a third set; and
appending the information with addresses of the at least one recipient of the third set, if the at least one recipient of the second set sent the copy of the document to the at least one recipient of the third set.

8. The method of claim 7, further comprising:
automatically enabling the copy of the revised version of the document to be sent to the at least one recipient of the first, second, and third sets when the revised version of the document is saved.

9. The method of claim 8, wherein automatically enabling further comprises:
providing a graphical user interface enabling the user to choose an option to send the copy of the revised version of the document.

10. The method of claim 2, further comprising:
automatically enabling the at least one recipient of the first set to obtain the copy of the revised version of the document if the at least one recipient of the first set accesses the copy of the document.

11. The method of claim 10, wherein automatically enabling further comprises:
providing a graphical user interface enabling a user to select an option to obtain the copy of the revised version of the document upon accessing the copy of the document.

12. The method of claim 10, wherein automatically enabling further comprises:
selecting a threshold, the attainment of which enables the copy of the revised version of the document to be obtained upon accessing the copy of the document.

13. The method of claim 12, wherein the threshold is one of a date, a day, and a time.

14. The method of claim 10, wherein automatically enabling comprises:
providing a graphical user interface that allows the user to change the information so that the at least one recipient of the first set receives the copy of the revised version of the document every time the at least one recipient accesses the copy of the document.

15. A communications system, comprising:
a document-sending system configured to:
determine whether a user sent a copy of a document to a first set of at least one recipient; and
correlate information with the document so that a copy of a revised version of the document can be sent automatically, if the user sent the copy of the document to the at least one recipient of the first set.

16. The communications system of claim 15, wherein the document-sending system is further configured to:
determine whether the user sent the copy of the document to at least one recipient of a second set; and
append the information with addresses of the at least one recipient of the second set, if the user sent the copy of the document to the at least one recipient of the second set.

17. The communications system of claim 16, wherein the document-sending system is further configured to:
determine whether the at least one recipient of the second set sent the copy of the document to at least one recipient of a third set; and
append the information with addresses of the at least one recipient of the third set, if the at least one recipient of the second set sent the copy of the document to the at least one recipient of the third set.

18. The communications system of claim 17, wherein the document-sending system is further configured to:
automatically enable the copy of the revised version of the document to be sent to the at least one recipient of the first set when the revised version of the document is saved.

19. The communications system of claim 15, wherein the document-sending system further comprises:
means for automatically enabling the at least one recipient of the first set to obtain the copy of the revised version of the document if the at least one recipient of the first set accesses the copy of the document.

20. The communications system of claim 19, wherein the means for automatically enabling, comprises:
means for selecting a threshold, the attainment of which enables the copy of the revised version of the document to be obtained upon accessing the copy of the document.

21. The communications system of claim 19, wherein the means for automatically enabling provides a graphical user interface that allows the user to change the information so that the at least one recipient of the first set receives the copy of the revised version of the document every time the at least one recipient accesses the copy of the document.

22. A computer-readable medium storing a computer program for sending documents, the computer-readable medium comprising:
logic configured to determine whether a user sent a copy of a document to a first set of at least one recipient; and
logic configured to correlate information with the document so that a copy of a revised version of the document can be sent automatically, the logic correlates the information if the user sent the copy of the document to the at least one recipient of the first set.

23. The computer-readable medium of claim 22, further comprising:
logic configured to determine whether the user sent the copy of the document to at least one recipient of a second set; and
logic configured to append the information with addresses of the at least one recipient of the second set, the logic appends if the user sent the copy of the document to the at least one recipient of the second set.

24. The computer-readable medium of claim 23, further comprising:
logic configured to determine whether the at least one recipient of the second set sent the copy of the document to at least one recipient of a third set; and
logic configured to append the information with addresses of the at least one recipient of the third set, the logic appends if the at least one recipient of the second set sent the copy of the document to the at least one recipient of the third set.

25. The computer-readable medium of claim 24, further comprising:
logic configured to automatically enable the copy of the revised version of the document to be sent to the at least one recipient of the first set, the logic automatically enables when the revised version of the document is saved.

26. The computer-readable medium of claim 22, further comprising:
logic configured to automatically enable the at least one recipient of the first set to obtain the copy of the revised version of the document, the logic automatically enables if the at least one recipient of the first set accesses the copy of the document.
